(19) United States
(12) Patent Application Publication
(10) Pub. No.: US 2006/0122959 A1
(43) Pub. Date: Jun. 8, 2006

(54) Systems and methods for organizing, sharing, and communicating data

(76) Inventors: Chris Hample, Salt Lake City, UT (US); Conrad Brandt, Salt Lake City, UT (US); Rebecca Hample, Salt Lake City, UT (US); Brent Lowther, Salt Lake City, UT (US); Libby Lowther, Salt Lake City, UT (US)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/268,693

(22) Filed: Nov. 7, 2005

Related U.S. Application Data
(60) Provisional application No. 60/626,000, filed on Nov. 8, 2004.

(51) Int. Cl. G06F 17/30

(52) U.S. Cl. 707/1

(57) ABSTRACT

In an exemplary method, file types, captions, and sections are defined. Relationships among the file types, the captions, and the sections are also defined. In response to a request from a client browser to view data that is associated with a file type, a web page file is generated. The web page file includes browser instructions that direct a client browser to display captions that are associated with the file type at a first level of an indented tree structure, to display sections that are associated with the displayed captions at a second level of the indented tree structure, and to display data items that are associated with the displayed sections at no higher than a third level of the indented tree structure. The web page file is sent to the client browser.

### RELATED APPLICATIONS

This application is related to and claims priority from U.S. Provisional Patent Application Ser. No. 60/626,000 filed Nov. 8, 2004, for “Browser Office Framework System and Method,” with inventors Chris Hample, Conrad Brandt, Rebecca Hample, Brent Lowther, and Libby Lowther, which is incorporated herein by reference.

### TECHNICAL FIELD

The present invention relates generally to computers and computer-related technology. More specifically, the present invention relates to systems and methods for organizing, sharing, and communicating data.

### BACKGROUND

Typically, many different parties are involved in business processes, and they have a need to efficiently share and communicate information. It has become increasingly more common that parties who are employed by a business do not share the same physical office or are often out of the office where the business is housed. This situation can be advantageous to businesses, and is becoming increasingly more prevalent as technology advances. Some parties to the business process are independent entities, such as service providers, who contribute to or need access to information from the business. Many industries are highly dependent on maintaining and managing documents and keeping detailed records.

Known approaches for organizing, sharing, and communicating information include using multiple desktop applications specific to the business process. Typically, these applications consist of industry-specific database programs to capture the data, with a reporting module to disseminate statistical data (generally numerical) and limited text. Documents generated by the in-house system and those generated outside the in-house system are usually stored in separate applications, such as a word processing program and document management software. These solutions may not be adequate because it may be difficult for many users, especially remote users, to access and use the information. For example, it may be difficult to use the multiple applications used by the primary business. In addition, outside users may have their own (and possibly conflicting) applications. Training may also be difficult. Desktop applications generally have a unique user interface.

Recently, some applications have become “browser-based” by moving a previously existing desktop application to a browser-based Internet or intranet application. However, the standard process of porting an existing desktop application and the desktop paradigm to a browser has not created an application that is usable without (often extensive) training. Many of the parties outside the principal business, and even some within it, may be reluctant to properly utilize such applications due to the time and effort that may be required to become proficient on the system. Moreover, in many cases, the transition of existing applications to the web has not solved the need for multiple applications to gather information. In addition, known web-based applications may not organize and present information in a logical and familiar manner. This may lead to gaps in documentation or retrievable information that can make a computer solution more time consuming and less efficient than paper files. This may explain business resistance to rely on computers to entirely manage the business process.

In view of the foregoing, benefits may be realized by improved systems and methods for organizing, sharing, and communicating data. Some exemplary systems and methods are disclosed herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates a system for organizing and presenting data that is configured according to an embodiment, the system including a database in which file types, captions, and sections are defined;

FIGS. 2-5 illustrate various possible relationships between file types, captions, and sections;

FIG. 6 illustrates a displayed web page which shows at least some of the data associated with an instance of a file type (i.e., a virtual file) being displayed in a caption/section format;

FIG. 7 illustrates various user interface elements that may be provided to facilitate the addition of a new data item;

FIG. 8 illustrates how data that is displayed to the user may be dynamically updated to reflect changes that are made to the database;

FIGS. 9A-9B illustrate how a web page that is displayed to a user may be dynamically updated to reflect modifications that are made to the database;

FIG. 10 illustrates some exemplary tables that may be used to organize data into file types, captions, and sections;

FIG. 11 illustrates additional functionality that may be performed by the database application;

FIG. 12 illustrates a displayed web page which shows at least some of the data associated with a file type being displayed in a view other than the caption/section view;

FIGS. 13A-B illustrate additional information that may be maintained in the database in order to implement the functionality of providing different levels of access to the data to different users;

FIG. 14 is a flow diagram which illustrates a method for creating a new instance of a file type;

FIG. 15 is a flow diagram which illustrates a method for displaying the data associated with an instance of a file type; and

FIG. 16 is a block diagram illustrating the major hardware components typically utilized in a computer system.

### DETAILED DESCRIPTION

Systems and methods for organizing, sharing, and communicating data are disclosed. In accordance with an embodiment, file types, captions, and sections are defined. Relationships among the file types, the captions, and the sections are also defined. In response to a request from a client browser to view data that is associated with a file type, a web page file is generated. The web page file includes browser instructions that direct a client browser to display captions that are associated with the file type at a first level of an indented tree structure, to display sections that are associated with the displayed captions at a second level of the indented tree structure, and to display data items that are associated with the displayed sections at no higher than a third level of the indented tree structure. The web page file is sent to the client browser.

Defining relationships among the file types, the captions, and the sections may involve associating each caption in the database with at least one type of file. In addition, each section in the database may be associated with a caption. Also, each of a plurality of data items may be bound to one or more bound parents.

Modification instructions may be received from the client browser to modify at least some of the data that is associated with the file type. Each time that new modification instructions are received, the database may be modified in accordance with the modification instructions. In addition, the browser instructions in the web page file may be modified to reflect modifications that have been made to the database, and the web page file with the modified browser instructions may be resent to the client.

Modifying the database may involve adding a new data item to the database, and binding the new data item to at least one bound parent. Alternatively, or in addition, modifying the database may involve adding a new section to the database, and associating the new section with a caption. Alternatively, or in addition, modifying the database may involve adding a new caption to the database, and associating at least one section with the new caption.

In some embodiments, in response to a client request the browser instructions in the web page file may be modified so as to direct the client browser to display an alternate view of the data other than a caption/section view. The modified web page file may be sent to the client.

In some embodiments, in response to detecting occurrence of an event, a business process rule associated with the event is identified and executed. Also, in some embodiments, different levels of access to the data may be provided to different users.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

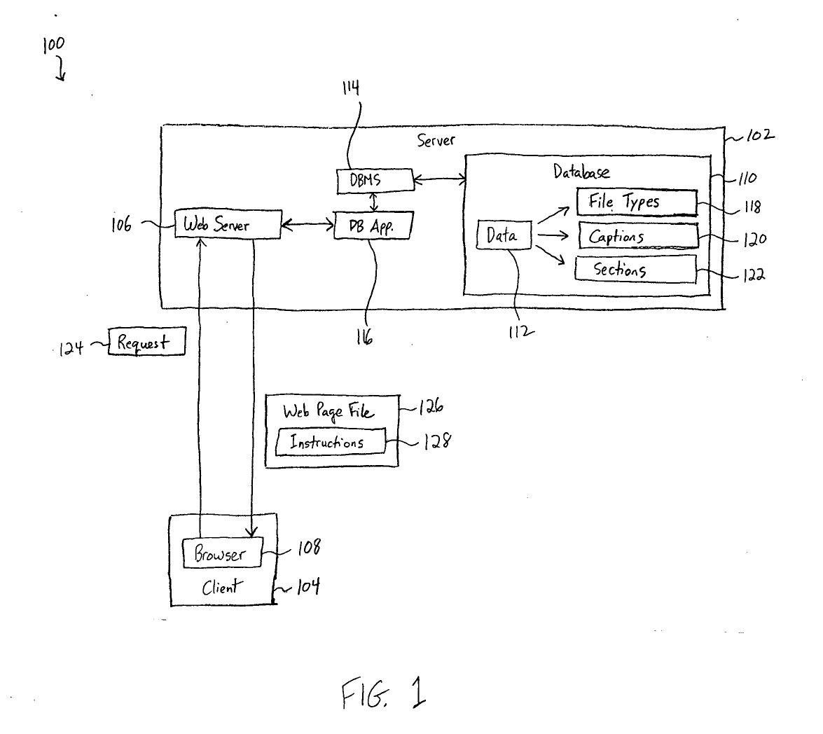

FIG. 1 illustrates a system 100 for organizing and presenting data that is configured according to an embodiment. A server 102 is in electronic communication with a client 104. Communication between the server 102 and the client 104 may occur, for example, via the Internet. A web server 106 is provided on the server 102. The web server 106 accepts HTTP requests from web browsers, such as the web browser 108 on the client 104. An example of a web server 106 that may be used is Microsoft Internet Information Services® (IIS).

A database 110 is provided on the server 102. The database 110 is an organized collection of data 112. A database management system (DBMS) 114 and a database application 116 are provided on the server 102. The DBMS 114 and the database application 116 together manage the database 110 and run operations on the data 112. An example of a DBMS 114 that may be used is Microsoft SQL Server®. The web server 106 works with the database application 116 and the DBMS 114 when requests are received for information from the database 110.

A plurality of file types 118, captions 120, and sections 122 are defined in the database 110. File types 118, captions 120, and sections 122 provide a conceptual framework for organizing the data 112 into virtual files. A file type 118 can be thought of as a type of virtual file. (Another word that may be used to describe a file type 118 is a perspective.) A caption 120 can be thought of as a major category for collecting information. Sections 122 are also categories for collecting information, but are more specific than captions 120.

In the context of processing and tracking insurance claims, some examples of possible file types 118 include Claim, Incident, Member, Policy, etc. For the Claim file type 118, some examples of possible captions 120 include Claimant/Plaintiff Counsel, Member Name, Loss Control, etc. For the Claimant/Plaintiff caption 120, some examples of possible sections 122 include Attorney, Associates, Firm, and Attorney Reputation.

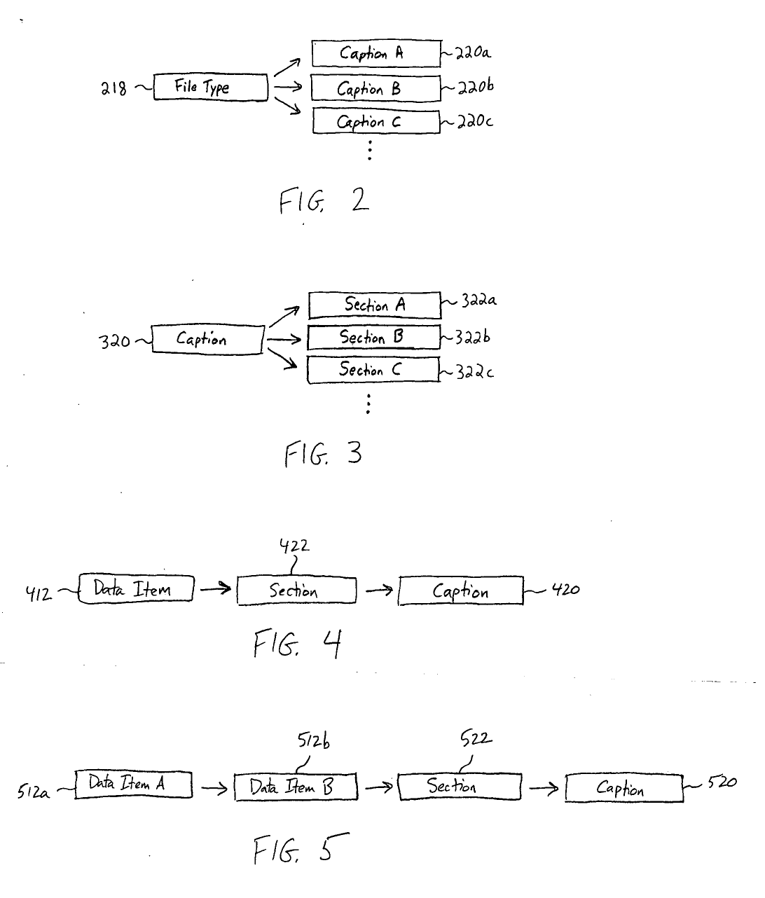

FIGS. 2-5 illustrate various possible relationships between file types 118, captions 120, and sections 122. One file type 118 may be associated with multiple captions 120. FIG. 2 illustrates a single file type 218 being associated with multiple captions 220, namely caption A 220a, caption B 220b, and caption C 220c. Also, a caption 120 may be shared among multiple file types 118 (this is not shown in FIG. 2).

In the illustrated embodiment, some or all of the captions 120 in the database 110 are associated with at least one section 122. Conversely, each section 122 in the database 110 is associated with one caption 120. In particular, a section 122 may be bound to a virtual file, which is associated with one caption 120. FIG. 3 illustrates a single caption 320 being associated with multiple sections 322, namely section A 322a, section B 322b, and section C 322c.

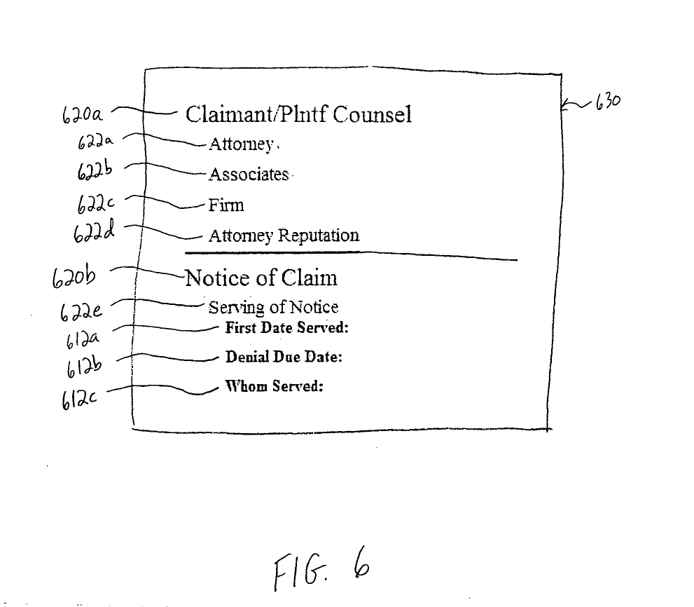

Each item of data 112 in the database 110 is bound to one or more bound parents. In this context, a bound parent refers to either a bound section 122 (i.e., a section 122 that is bound to a virtual file) or a bound data item 112 (i.e., a data item 112 that is bound to another bound parent). FIG. 4 illustrates a single data item 412 being bound to a section 422 that is bound to a caption 420. FIG. 5 illustrates data item A 512a being bound to a bound data item, namely data item B 512b. Data item B 512b is bound to a section 522 that is associated with a caption 520.

Referring again to FIG. 1, a user of the client 104 may want to view all of the data 112 that is associated with a particular file type. When this occurs, the user may initiate the client browser 108 sending a request 124 to the web server 106 for a web page file 126 (e.g., an HTML file) that includes the requested data 112. In response to receiving the request 124 from the client browser 108, the web server 106 generates a web page file 126 to send to the client browser 108. The web page file 126 includes instructions 128 for directing the client browser 108 to display the data 112 that is associated with the desired file type 118. The instructions 128 are configured so that the data 112 is displayed in a particular format, referred to as the caption/section format. The caption/section format will be discussed immediately below. The web server 106 sends the web page file 126 to the client browser 108, which displays the data 112 in the caption/section format.

FIG. 6 illustrates a displayed web page 630 which shows at least some of the data associated with a file type (i.e., a virtual file) being displayed in the caption/section format. In the illustrated example, the Claim file type is used. Two captions 620 are associated with the Claim file type, namely Claimant/Plaintiff Counsel 620a and Notice of claim 620b. Four sections 622 are associated with the Claimant/Plaintiff Counsel caption 620a, namely Attorney 622a, Associates 622b, Firm 622c, and Attorney Reputation 622d. One section 622 is associated with the Notice of Claim caption 620b, namely Serving of Notice 622e. Three data items 612 are bound to the Serving of Notice section 622e, namely First Date Served 612a, Denial Due Date 612b, and Whom Served 612c.

As shown, in the caption/section format information is presented in an indented tree structure. The captions 620 associated with the illustrated file type (i.e., Claimant/Plaintiff Counsel 620a and Notice of claim 620b in the illustrated example) are displayed at the first level of the indented tree structure. The sections 622 that are bound to the virtual file (Attorney 622a, Associates 622b, Firm 622c, and Attorney Reputation 622d for the Claimant/Plaintiff Counsel caption 620a; Serving of Notice 622e for the Notice of Claim caption 620b) are displayed at the second level of the indented tree structure. Data items 612 are displayed no higher than the third level of the indented tree structure. In the illustrated example, the data items 612 (i.e., First Date Served 612a, Denial Due Date 612b, and Whom Served 612c) are each displayed at the third level of the indented tree structure. However, they may be displayed at lower levels of the indented tree structure (for example, when one data item 612 is bound to another data item 612).

While viewing the data associated with a particular type of file/virtual file, the user may decide that he/she wants to modify at least some of the data that is associated with the type of file. For example, the user may want to add/delete new data items, etc.

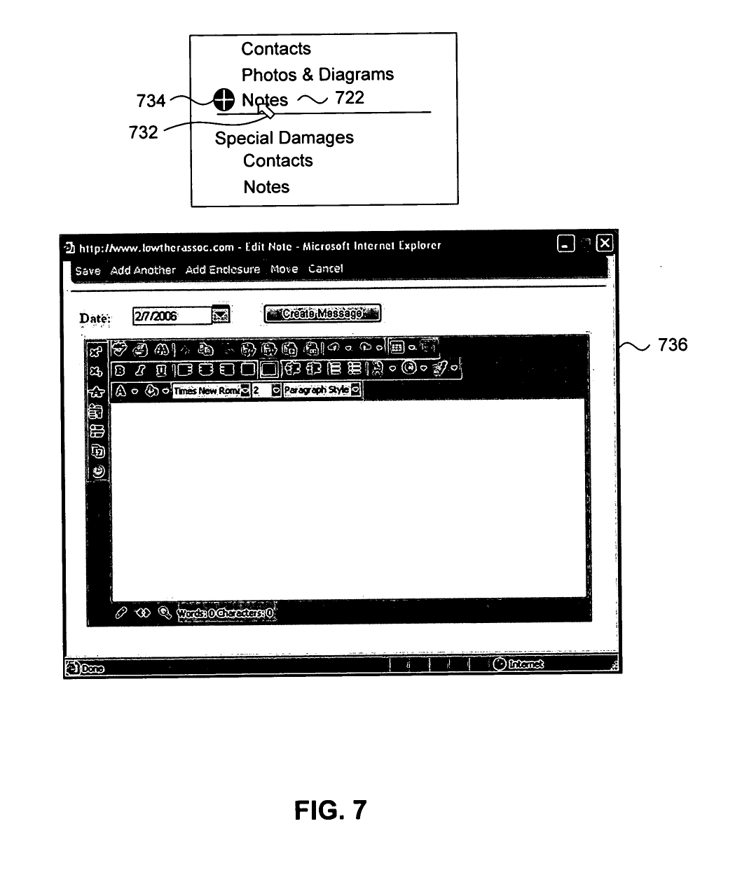

FIG. 7 illustrates various user interface elements that may be provided to facilitate the addition of a new data item. In the illustrated example, the user would like to add a new data item to a section 722 labeled Notes. To do this, the user moves the mouse arrow 732 over the Notes section 722. In response, a button 734 is displayed next to the Notes section 722. The button 734 is associated with an action for modifying the Notes section 722. In the illustrated example, the button 734 is an add button that is associated with the action of adding data items. The user activates the add button 734 (e.g., by clicking on it) and, in response, the action associated with the button 734 is executed. In particular, a new window 736 is displayed for entering the data item to be added.

In alternative embodiments, multiple buttons may be displayed when the user moves the mouse arrow 732 over a particular caption, section, etc. For example, in addition to an add button, a delete button and/or an edit button may also be displayed.

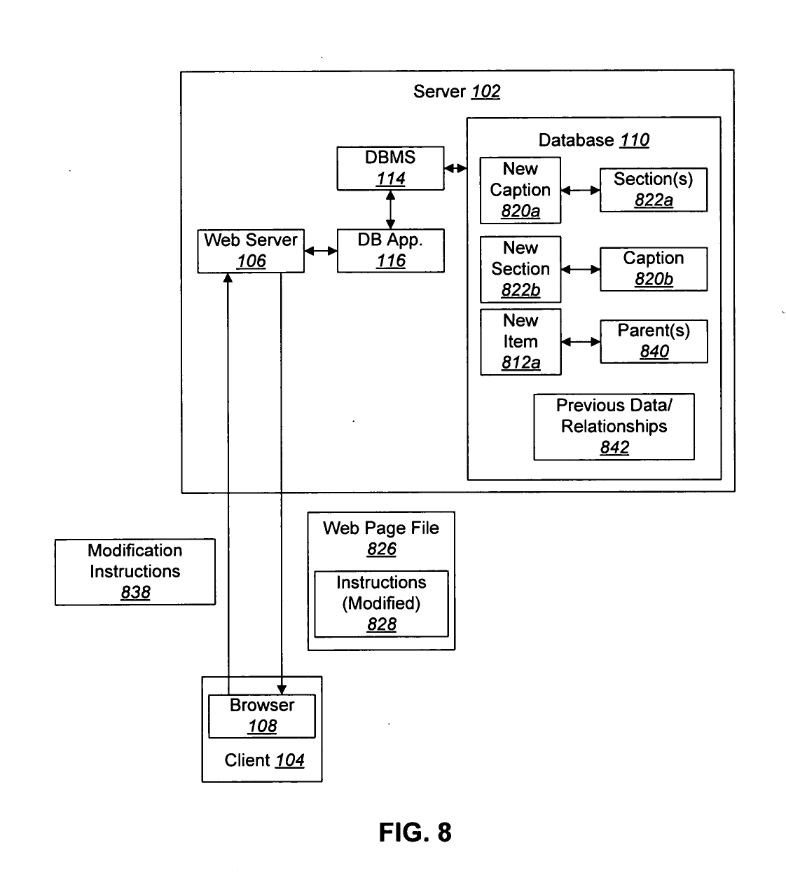

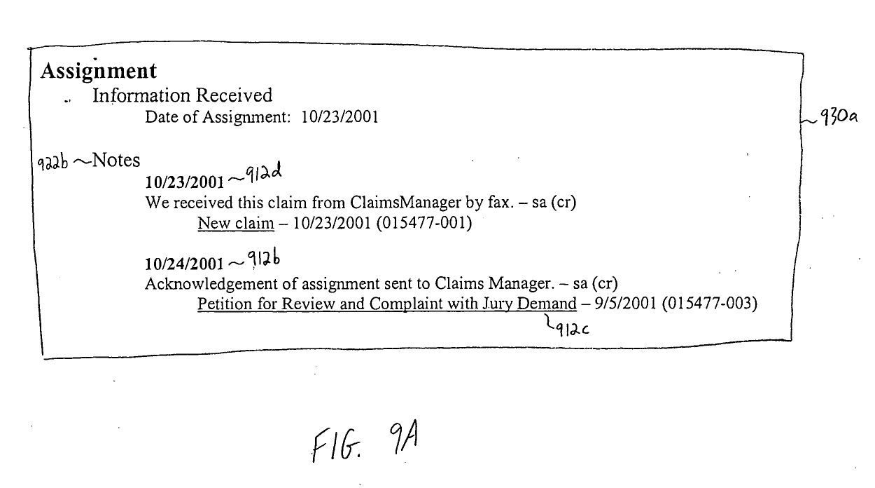

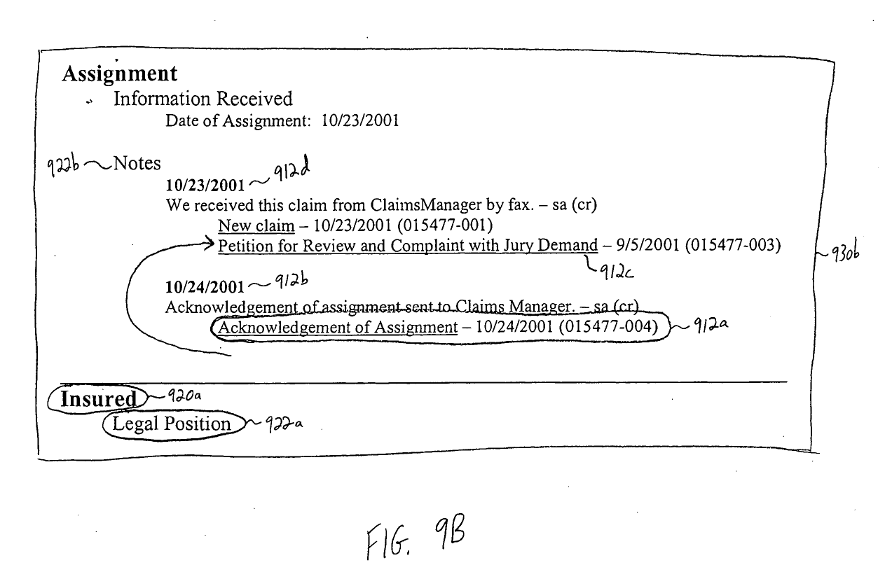

FIG. 8 illustrates how data that is displayed to the user may be dynamically updated to reflect changes that are made to the database 110. The user may take some action (e.g., clicking on a button) that causes the client browser 108 to send modification instructions 838 to the web server 106. The modification instructions 838 are instructions to modify at least some of the data associated with the file type.

Each time that modification instructions 838 are received from the client browser 108, the database application 116 and DBMS 114 work together to modify the database 110 in accordance with the modification instructions 838. The web server 106, database application 116, and DBMS 114 work together to modify the browser instructions 828 in the web page file 826 to reflect modifications that have been made to the database 110. The web server 106 resends the web page file 826 with the modified browser instructions 828 to the client browser 108.

Many different kinds of modifications may be made to the database 110. In the example shown in FIG. 8, a new caption 820a is added to the database 110. The new caption 820a is associated with at least one section 822a. Also, a new section 822b is added to the database 110. The new section 822b is bound to a caption 820b. In addition, a new data item 812a is added to the database 110. The new data item 812a is bound to at least one bound parent 840 (either a bound section or a bound data item, as discussed above). The database 110 is updated to include these modifications relative to previous data/relationships 842 (i.e., the data that was previously in the database 110 and the relationships between the file types, captions, and sections that previously existed).

FIGS. 9A-9B illustrate how a web page 930 that is displayed to a user may be dynamically updated to reflect modifications that are made to the database 110. FIG. 9A illustrates the web page 930a before the modifications are made to the database 110. FIG. 9B illustrates the web page 930b after the modifications are made to the database 110.

In the illustrated example, a new caption 920a (Insured) and a new section 922a (Legal Position) are added to the database 110. The new caption 920a is associated with the displayed type of file. The new section 922a is bound to the file type/virtual file and associated with the displayed caption 920a. Therefore, the new section 922a is displayed underneath the new caption 920a in the caption/section view. The new caption 920a and the new section 922a are circled in FIG. 9B to indicate that they have been added (these markings may not be displayed in the actual web page 930b that is displayed to the user).

In addition, a new data item 912a (the enclosure titled Acknowledgement of Assignment) is added to the database 110. This new data item 912a is bound to the entry 912b dated Oct. 24, 2001, which is bound to the Notes section 922b. Consequently, this new data item 912a is displayed underneath the entry 912b dated Oct. 24, 2001 in the caption/section view. The new data item 912a is circled in FIG. 9B to indicate that it has been added.

In addition, another data item 912c (the enclosure titled Petition for Review and Complaint with Jury Demand) is moved from the entry 912b dated Oct. 24, 2001 to the entry 912d dated Oct. 23, 2001. Making this modification within the database involves unbinding the enclosure 912c from the entry dated Oct. 24, 2001, and then binding the enclosure 912c to the entry dated Oct. 23, 2001.

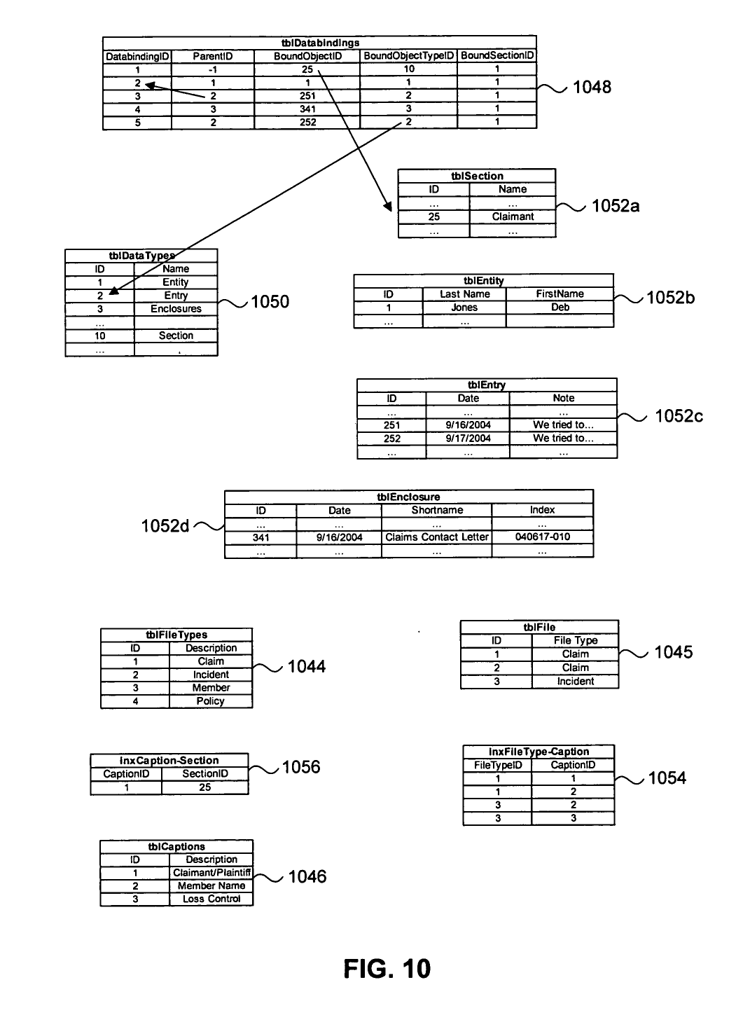

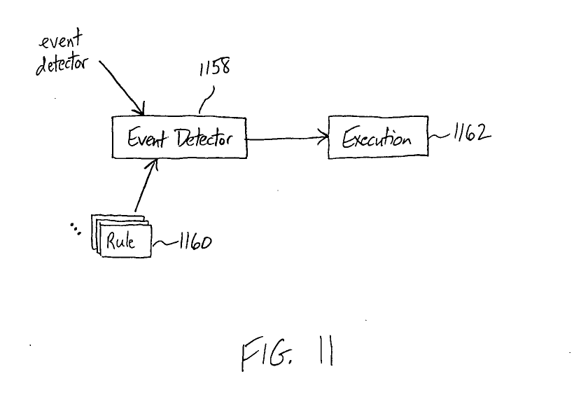

FIG. 10 illustrates some exemplary tables that may be used to organize data 112 into file types 118, captions 120, and sections 122. The illustrated tables include a file types table 1044 (tblFileTypes), a captions table 1046 (tblCaptions), a data bindings table 1048 (tblDatabindings), a data types table 1050 (tblDataTypes), a data types table 1050, a separate table 1052 for each record in the data types table 1050 (tblSection 1052a, tblEntity 1052b, tblEntry 1052c, and tblEnclosure 1052d), a file type-caption linking table 1054 (inxFileType-Caption), and a caption-section linking table 1056 (inxCaption-Section).

To add a new caption 120 to the database 110, a new record for the caption 120 is created in the captions table 1046 (tblCaptions). To add a new section 122 to the database 110, a new record for the section 122 is created in the sections table 1052a (tblSections).

To associate a caption 120 with a section 122, a new record is created in the caption-section linking table 1056 (inxCaption-Section). The caption-section linking table 1056 includes a CaptionID column and a SectionID column. The CaptionID column is set equal to the ID for the desired caption 120 in the captions table 1046. The SectionID column is set equal to the ID for the desired section 122 in the sections table 1052a. To associate a caption 120 with N sections 122, N records are created in the caption-section linking table 1056.

There may be different types of data items 112 in the database 110. Some examples of different data types include entities (e.g., contacts), entries (e.g., notes), enclosures (e.g., scanned documents), links to reports or functions, etc. A section 122 may be thought of as a type of data item 112. The data types table 1050 includes a record for each type of data item 112 in the database 110. Also, a separate table is provided for each type of data item 112 (tblSection 1052a, tblEntity 1052b, tblEntry 1052c, and tblEnclosure 1052d).

To add a new data item 112 to the database 110, the data type of the data item 112 is registered in the data types table 1050 (tblDataTypes), and a new table 1052 is created for the data type of the data item 112 (e.g., tblEntity 1052b for entities, tblEntry 1052c for entries, etc.). (These steps are not necessary if the data type has already been registered and a table has already been created for the data type.) Then a new record for the data item 112 is created in the table for the appropriate data type (e.g., if a new entity is being added, then a new record is created in tblEntity 1052b).

The data bindings table 1048 (tblDatabindings) may be used to bind a data item 112 to a bound parent (either a bound section or a bound data item, as discussed above). The data bindings table 1048 includes a data binding ID column and a parent ID column. To bind a data item to a bound parent, a new record for the data item 112 in the data bindings table 1048 is created. The parent ID of the record is set equal to the data binding ID of the bound parent to which the data item 112 is being bound. For example, the third record in the data bindings table 1048 binds the entry dated Sep. 16, 2004 to the entity named Deb Jones. This is done by setting the parent ID of the record for the Sep. 16, 2004 entry equal to the data binding ID of the record for the Deb Jones entity. The data bindings table 1048 may also be used to change the parent to which a particular data item 112 is bound. This may be accomplished by changing the parent ID of the record for the data item 112.

A tblFile table 1045 may also be provided. As indicated above, the tblFileTypes table 1044 lists the types of available files. The tblFile table 1045 contains the unique instances of those different file types.

FIG. 11 illustrates additional functionality that may be performed by the database application 116. An event detector 1158 (e.g., a system watcher) may be provided that is configured to detect events that trigger the application of business process rules 1160. When the event detector 1158 detects the occurrence of an event that is associated with a business process rule 1160, it instructs a rule execution component 1162 to execute the rule.

There are many different kinds of events that may be detected. In the context of processing and tracking insurance claims, an example of an event that may be detected is creating a new file. Some examples of business process rules that may be executed when a new file is created include notifying subscribers, setting up financial reserves, etc. Another example of an event that may be detected is an adjuster being assigned to a claim by adding their contact to the Adjusters section. An example of a business process rule that may be executed in response to this event is notifying the adjuster that he/she has been assigned to this claim. Some other examples of events that may be detected include adding data items (e.g., notes, contacts, etc.) to sections, making a payment request, etc.

If an event is initiated by a user, the event detector may determine whether the user is authorized to perform the event (e.g., is the user authorized to make a payment request). However, events do not have to be initiated by a user. For example, a detectable event may be that a certain amount of time has passed without a predefined action taking place during this time (e.g., 30 days have passed since a note was added).

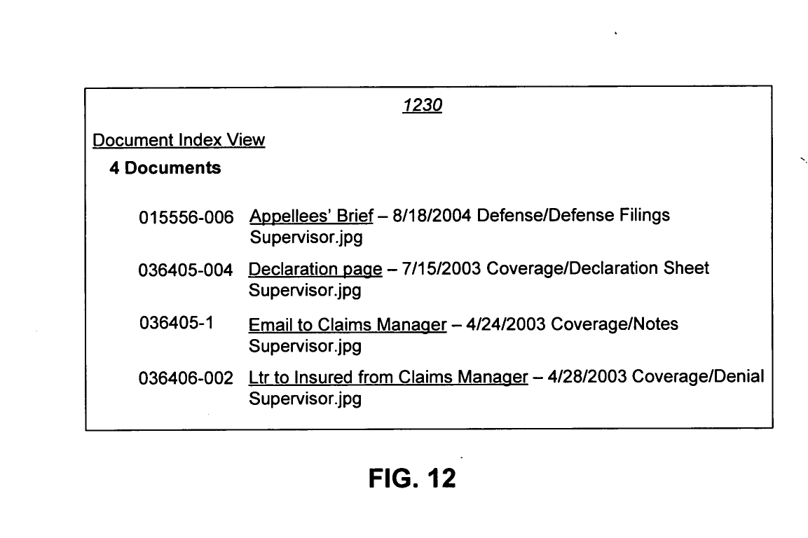

The caption/section format can be thought of as a kind of “view” for the data. Different views of the data may also be provided. While viewing data in the caption/section view, the user may decide that he/she wants the data to be presented in a different view. FIG. 12 illustrates a displayed web page 1230 which shows at least some of the data associated with a file type being displayed in a view other than the caption/section view. The illustrated data is shown in a view called the document index view.

To generate an alternate view, such as the document index view, the user may take some action that causes the client browser 108 to send a request to the web server 106 for an alternate view of the data. In response to the request, the web server 106, database application 116, and DBMS 114 work together to modify the browser instructions in the web page file 126. The modified browser instructions direct the client browser 108 to display the desired alternate view of the data. The web server 106 sends the web page file 126 with the modified browser instructions to the client browser 108, which displays the alternate view of the data.

Different users may access and view the data maintained in the database. Different viewing privileges, or rights, may be assigned to different users. In this way, sensitive data may be protected so that it is not accessible by individuals who should not have access to it. For example, in the context of processing and tracking insurance claims, it may be desirable to prevent defense attorneys from seeing an insurance company's confidential financial information (e.g., an insurance company's reserve allocation).

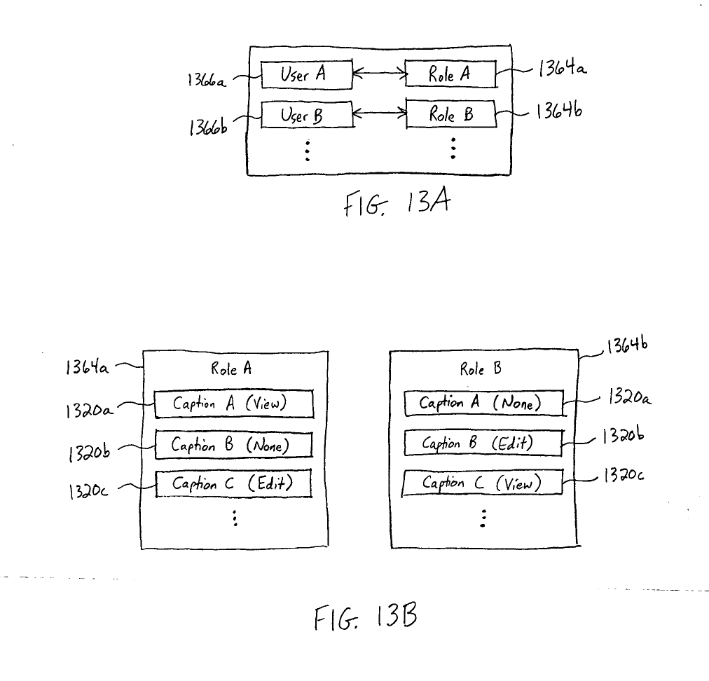

FIGS. 13A-B illustrate additional information that may be maintained in the database 110 in order to implement the functionality of providing different levels of access to the data to different users. As shown in FIG. 13A, different roles 1364 may be defined. The roles 1364 reflect the varying rights/interests of the different individuals who may access the database 110. At least one role 1364 may be associated with each user 1366 that is registered to use the database 110. In the illustrated example, two users 1366 are shown: user A 1366a and user B 1366b. User A 1366a is associated with role A 1364a. User B 1366b is associated with role B 1364b.

As shown in FIG. 13B, one or more captions 1320 may be assigned to each role 1364. Each combination of role 1364 and caption 1320 may be assigned a value of Edit, View, or None. If the Edit value is assigned to combination of a role 1364 and a caption 1320, this means that users 1366 associated with that role 1364 are allowed to edit the information (e.g., the data items 112) associated with that caption 1320. If the View value is assigned, users 1366 associated with that role 1364 are allowed to view, but not edit, the information. If the None value is assigned, users 1366 associated with that role 1364 are not allowed to edit or view the information.

In the example shown in FIG. 13B, the combination of role A 1364a and caption A 1320a is assigned a value of View, while the combination of role B 1364b and caption A 1320a is assigned a value of None. The combination of role A 1364a and caption B 1320b is assigned a value of None, while the combination of role B 1364b and caption B 1320b is assigned a value of Edit. The combination of role A 1364a and caption C 1320c is assigned a value of Edit, while the combination of role B 1364b and caption C 1320c is assigned a value of View. Thus, when user A 1366a requests to view the data, caption A 1320a and caption C 1320c are displayed, but caption B 1320b is not displayed. User A 1366a is able to edit caption C 1320c, but is not able to edit caption A 1320a. When user B 1366b requests to view the data, caption B 1320b and caption C 1320c are displayed, but caption A 1320a is not displayed. User B 1366b is able to edit caption B 1320b, but is not able to edit caption C 1320c.

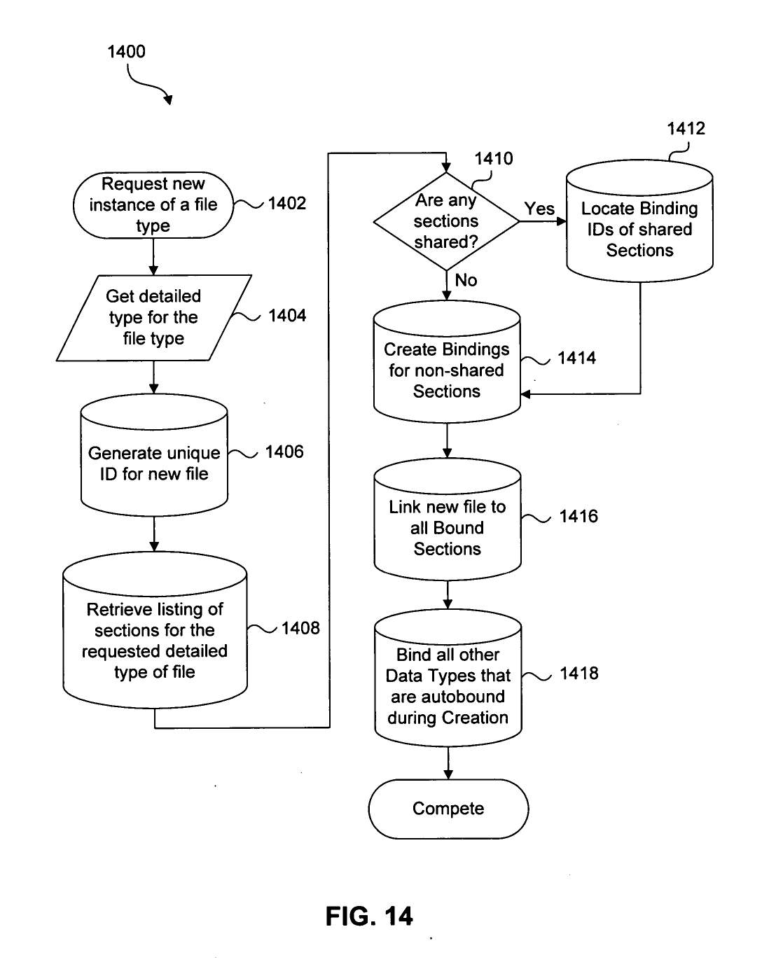

FIG. 14 is a flow diagram which illustrates a method 1400 for creating a new instance of a file type. In step 1402, a new instance of a file type is requested. In step 1404, the detailed type for the file type is obtained. Type detail is a subclass of the type of file type. For example, in property damage claims, the Property Damage Section may be included, but not the Injury section, which may be included in Injury claims. In both cases, a file is created that determines which sections belong in that file type.

In step 1406, a unique identifier is generated for the new file. This identifier is stored in the tblFile table. In step 1408, a listing of sections is retrieved for the requested detailed type of file.

In step 1410, it is determined whether any sections are shared. Since an instance of a file type is made up of bound sections, multiple file types may share the same bound sections. Using the example of claim files, suppose that an event occurs involving multiple parties for which separate claims are created. Rather than copy the same information about the nature of the event in each separate claimant's file, the sections that pertain to all claims are shared. Data added in one claim file in a shared section is reflected in all of the files. Since data is attached to bound sections in the same way regardless of the type of file, it is also possible to share bound sections amongst the different files. Continuing the claims file example, information about policy coverage is contained in the insured file type, but it is also included in every claim file made against the insured. The table that links file type to captions (the inxFileTypes-Caption table 1054) describes how the sharing is to be set up during the creation process.

If at least one section is shared, then in step 1412 the BindingIDs of shared sections are located. In step 1414, new bindings are created for non-shared sections. In step 1416, the new file is linked to all bound sections.

In step 1418, all other data types that are auto bound during creation are bound. There are some data types outside of sections that are to be bound during this process. Like sections, these data types either are needed to customize the user interface (e.g., functions) or create placeholders to capture more detailed information, for example binding of all of the items, such as file number, date created, closing date, filename, etc. No data is created, but a place is created to hold the data to be entered by the user.

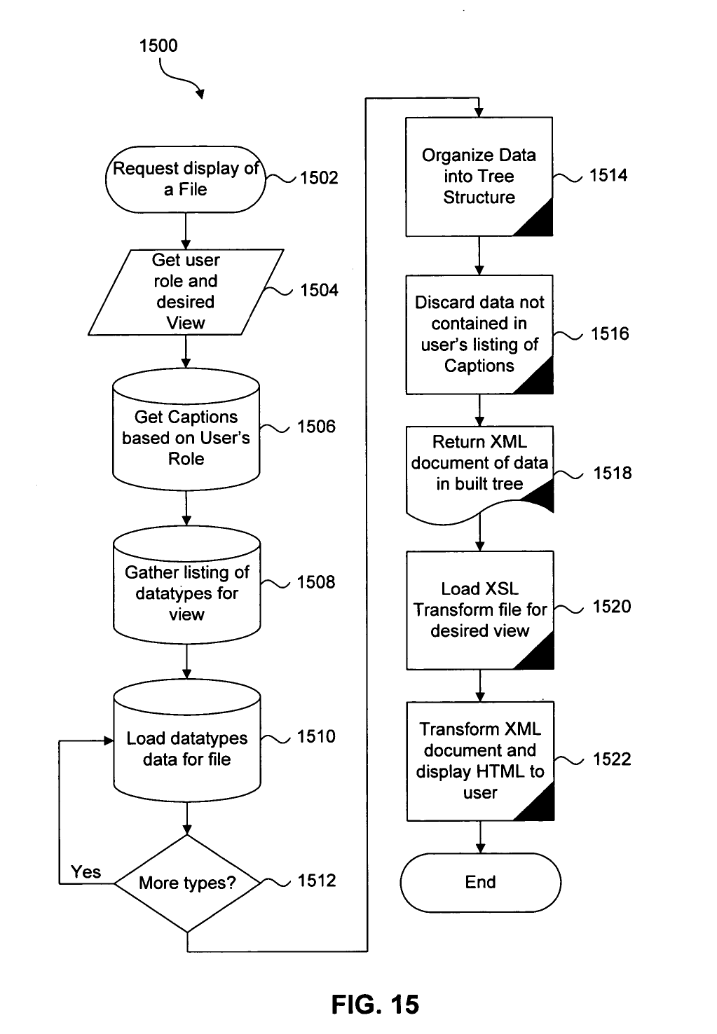

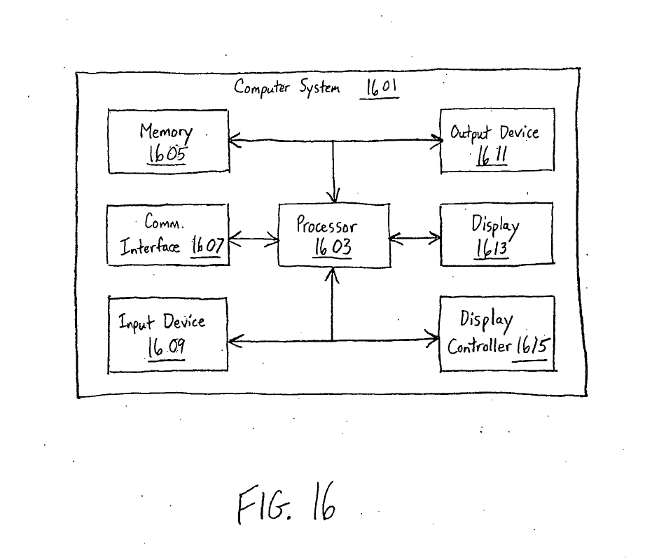

FIG. 15 is a flow diagram which illustrates a method 1500 for displaying the data associated with a file type (a virtual file). In step 1502, a request is made to display a virtual file. In response, in step 1504 the user role and desired view (e.g., caption/section view, document index view, etc.) are obtained. A view indicates the XSL transform file to use, what data types are included, what sections are explicitly excluded, how the data is to be sorted, and what title is to be used. In step 1506, the captions to display in the virtual file are obtained based on the user's role.

In step 1508, a listing of the data types for the data items in the view is gathered. In step 1510, the data types data for the file is loaded. Step 1510 continues to be repeated as long as it is determined 1512 that there are more data types to be loaded.

In step 1514, the data items are organized into a tree structure. All of the data items are loaded for the virtual file. In step 1516, the data items that are not contained in the user's listing of captions are discarded. In other words, if a user does not have rights to data in a particular section, it will be left over (discarded) during the tree building process.

In step 1518, an XML document of the data in the built tree is returned. The ibindable interface used for data types contains a “to XML” function that may be used to generate the XML document. In step 1520, the XSL transform file for the desired view is loaded. In step 1522, the XML document is transformed according to the XSL transform file, and HTML is displayed to the user.

In the above discussion, some embodiments/examples have been described in relation to the processing and tracking of insurance claims. However, embodiments are not limited in this regard. Embodiments may be practiced in any environment where many different parties are involved in business processes.

FIG. 16 is a block diagram illustrating the major hardware components typically utilized in a computer system 1601. The illustrated components may be located within the same physical structure or in separate housings or structures.

The computer system 1601 includes a processor 1603 and memory 1605. The processor 1603 controls the operation of the computer system 1601 and may be embodied as a microprocessor, a microcontroller, a digital signal processor (DSP) or other device known in the art. The processor 1603 typically performs logical and arithmetic operations based on program instructions stored within the memory 1605.

As used herein, the term memory 1605 is broadly defined as any electronic component capable of storing electronic information, and may be embodied as read only memory (ROM), random access memory (RAM), magnetic disk storage media, optical storage media, flash memory devices in RAM, on-board memory included with the processor 1603, EPROM memory, EEPROM memory, registers, etc. The memory 1605 typically stores program instructions and other types of data. The program instructions may be executed by the processor 1603 to implement some or all of the methods disclosed herein.

The computer system 1601 typically also includes one or more communication interfaces 1607 for communicating with other electronic devices. The communication interfaces 1607 may be based on wired communication technology, wireless communication technology, or both. Examples of different types of communication interfaces 1607 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system 1601 typically also includes one or more input devices 1609 and one or more output devices 1611. Examples of different kinds of input devices 1609 include a keyboard, mouse, microphone, remote control device, button, joystick, trackball, touchpad, lightpen, etc. Examples of different kinds of output devices 1611 include a speaker, printer, etc. One specific type of output device which is typically included in a computer system is a display device 1613. Display devices 1613 used with embodiments disclosed herein may utilize any suitable image projection technology, such as a cathode ray tube (CRT), liquid crystal display (LCD), light-emitting diode (LED), gas plasma, electroluminescence, or the like. A display controller 1615 may also be provided, for converting data stored in the memory 1605 into text, graphics, and/or moving images (as appropriate) shown on the display device 1613.

Of course, FIG. 16 illustrates only one possible configuration of a computer system 1601. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A computer-implemented method for organizing, sharing, and communicating data, comprising:
defining in a database a plurality of file types, captions, and sections;
defining relationships among the file types, the captions, and the sections;
receiving a request from a client browser to view data that is associated with a file type;
in response to the request, generating a web page file to send to the client browser;
providing browser instructions in the web page file that direct a client browser to:
display captions that are associated with the file type at a first level of an indented tree structure;
display sections that are associated with the displayed captions at a second level of the indented tree structure; and
display data items that are associated with the displayed sections at no higher than a third level of the indented tree structure; and
sending the web page file to the client browser.

2. The method of claim 1, wherein defining relationships comprises:
associating each caption in the database with at least one type of file;
associating each section in the database with a caption; and
binding each of a plurality of data items to one or more bound parents, wherein each bound parent is either a bound section or a bound data item.

3. The method of claim 2, wherein binding a data item to a bound parent comprises creating a new record in a data bindings table.

4. The method of claim 2, further comprising:
receiving modification instructions from the client browser to modify at least some of the data that is associated with the file type; and
each time that new modification instructions are received:
modifying the database in accordance with the modification instructions;
modifying the browser instructions in the web page file to reflect modifications that have been made to the database; and
resending the web page file with the modified browser instructions to the client.

5. The method of claim 4, wherein modifying the database comprises:
adding a new caption to the database; and
associating at least one section with the new caption.

6. The method of claim 5, wherein adding the new caption to the database comprises creating a new captions table record, and wherein associating the new caption with the at least one section comprises creating at least one new caption/section linking table record.

7. The method of claim 4, wherein modifying the database comprises:
adding a new section to the database; and
associating the new section with a caption.

8. The method of claim 7, wherein adding the new section to the database comprises creating a new section table record, and wherein associating the new section with the at least one caption comprises creating at least one new caption/section linking table record.

9. The method of claim 4, wherein modifying the database comprises:
adding a new data item to the database; and
binding the new data item to at least one bound parent.

10. The method of claim 9, wherein adding the new data item to the database comprises creating a new data item table record, and wherein binding the new data item to the at least one bound parent comprises creating a new data binding table record.

11. The method of claim 4, wherein modifying the database comprises:
unbinding a data item from a first bound parent; and
binding the data item to a second bound parent.

12. The method of claim 11, wherein unbinding the data item from the first bound parent and binding the data item to the second bound parent comprises changing a parent identifier field in a data bindings table.

13. The method of claim 1, further comprising:
detecting occurrence of an event;
in response to detecting the occurrence of the event:
identifying a business process rule associated with the event; and
executing the business process rule.

14. The method of claim 1, further comprising providing different levels of access to the data to different users.

15. The method of claim 1, wherein the browser instructions in the web page file also direct the client browser to:
if the user has the appropriate rights for the caption, display at least one button that is associated with an action for modifying the data; and
in response to detecting activation of a displayed button, execute the action that is associated with the displayed button.

16. The method of claim 1, further comprising:
in response to a client request, modifying the browser instructions in the web page file so as to direct the client browser to display an alternate view of the data other than a caption/section view; and
sending the modified web page file to the client.

17. A computer system that is configured to implement a method for organizing, sharing, and communicating data, the computer system comprising:
a processor;
memory in electronic communication with the processor;
instructions stored in the memory, the instructions being executable to implement a method comprising:
defining in a database a plurality of file types, captions, and sections;
defining relationships among the file types, the captions, and the sections;
receiving a request from a client browser to view data that is associated with a file type;
in response to the request, generating a web page file to send to the client browser;
providing browser instructions in the web page file that direct a client browser to:
display captions that are associated with the file type at a first level of an indented tree structure;
display sections that are associated with the displayed captions at a second level of the indented tree structure; and
display data items that are associated with the displayed sections at no higher than a third level of the indented tree structure; and
sending the web page file to the client browser.

18. A computer-readable medium comprising executable instructions for implementing a method for organizing, sharing, and communicating data, the method comprising:
defining in a database a plurality of file types, captions, and sections;
defining relationships among the file types, the captions, and the sections;
receiving a request from a client browser to view data that is associated with a file type;
in response to the request, generating a web page file to send to the client browser;
providing browser instructions in the web page file that direct a client browser to:
display captions that are associated with the file type at a first level of an indented tree structure;
display sections that are associated with the displayed captions at a second level of the indented tree structure; and
display data items that are associated with the displayed sections at no higher than a third level of the indented tree structure; and
sending the web page file to the client browser.
